(19) United States
(12) Patent Application Publication
(10) Pub. No.: US 2011/0205318 A1
(43) Pub. Date: Aug. 25, 2011

(54) INK TANK CHECK VALVE FOR PRESSURE REGULATION

(76) Inventor: Brian G. Price, Pittsford, NY (US)

(21) Appl. No.: 12/711,491

(22) Filed: Feb. 24, 2010

(51) Int. Cl. B41J 2/175

(52) U.S. Cl. 347/86

(57) ABSTRACT

An ink tank having a tank body and an aperture leading to an outside of the tank body. A valve is biased to close the aperture but is movable to open the aperture by a reduced pressure within the tank body relative to an external pressure outside the tank body. The valve contacts a valve seat and is biased with a predetermined force against the valve seat by a spring. The predetermined force and the area of a contact region between the closing member and the valve seat determine how much pressure difference is needed to open the aperture.

### CROSS REFERENCE TO RELATED APPLICATIONS

Reference is made to commonly assigned U.S. patent application Ser. No. ______ filed concurrently herewith, entitled “Method for Ink Tank Pressure Regulation”, the disclosure of which is incorporated by reference herein in its entirety.

### FIELD OF THE INVENTION

The present invention relates generally to an ink tank for an inkjet printer, and more particularly to a device for regulating the pressure in the ink tank.

### BACKGROUND OF THE INVENTION

An inkjet printer typically includes one or more printheads and their corresponding ink supplies. A printhead includes an array of drop ejectors, each ejector consisting of an ink pressurization chamber, an ejecting actuator and a nozzle through which droplets of ink are ejected. The ejecting actuator may be one of various types, including a heater that vaporizes some of the ink in the pressurization chamber in order to propel a droplet out of the nozzle, or a piezoelectric device which changes the wall geometry of the pressurization chamber in order to generate a pressure wave that ejects a droplet. The droplets are typically directed toward paper or other recording medium in order to produce an image according to image data that is converted into electronic firing pulses for the drop ejectors as the print medium is moved relative to the printhead.

In some printers an ink reservoir can be located remotely from an intermediate ink supply that is co-located with the printhead. The remote reservoir can be connected to the intermediate ink supply, for example, by tubing in order to replenish the ink used by the printhead. Alternatively in other printers, an ink supply can be directly coupled to the printhead. For the case of ink supplies being mounted on the carriage of a carriage printer, the ink supply can be permanently mounted onto the printhead, so that the printhead needs to be replaced when the ink is depleted, or the ink supply can be detachably mounted onto the printhead, so that only the ink supply itself needs to be replaced when the ink is depleted.

An ink supply should be capable of containing the ink without leakage during manufacture, storage, transportation, and the printing operation itself. The ink supply should be capable of containing the ink even under conditions where the pressure within the ink supply changes due to environmental conditions. Pressure variations can occur, for example, due to changes in ambient temperature or barometric pressure during storage or transportation. During the printing operation ink should be held at a suitably negative pressure relative to ambient so that ink does not drool out of the nozzles, and yet not at an excessively negative pressure that would lead to ink starvation and dropout during printing. Various designs for regulating pressure within an inkjet ink supply are known including spring-biased bags, capillary media, and bubble generators.

It has been found that pigment particles in a pigmented ink can settle out in ink supply designs where ink is stored in a capillary media pressure regulator, partly due to the restriction of motion of pigment particles within the small passages of the capillary media, as described in more detail in commonly assigned US Published Patent Application 20090309940. Such settling of pigments particles, especially for larger pigment particles (e.g. larger than 30 nanometers), can result in defective images during the printing process. As a result, an ink supply using capillary media to store ink can lead to a limitation in pigment particle size that can be used. Such a limitation can be disadvantageous, because such larger particles can be beneficial for providing higher optical density in printed regions.

In addition to compatibility with inks of interest, other evaluation metrics for ink supply and pressure regulator designs include extractable ink per volume of the supply and the amount of variation of pressure versus amount of ink extracted from the supply. What is needed is an ink supply for a printhead that is capable of keeping the pressure substantially constant and within an acceptable range as ink is being used. For the case of ink supplies that are not replenished within the printer, the ink supply should preferably be able to deliver a volume of ink that is a substantial fraction of the volume of the ink supply, in order to help keep the design of the printer compact.

### SUMMARY OF THE INVENTION

The present invention is directed to overcoming one or more of the problems set forth above. Briefly summarized, according to one aspect of the invention, the invention resides in an ink tank for an inkjet printer. The ink tank includes a tank body and an aperture leading to an outside of the tank body. A valve is biased to close the aperture but is movable to open the aperture by a reduced pressure within the tank body relative to an external pressure outside the tank body. The valve is substantially spherically shaped. The valve contacts a valve seat and is biased with a predetermined force against the valve seat by a spring. The predetermined force and a contact region between the closing member and the valve seat determine how much pressure difference is needed to open the aperture.

Another embodiment of the present invention includes an inkjet printer with a printhead, and an ink tank for the printhead. The ink tank includes a tank body and an aperture leading to outside the tank body. A valve is biased to close the aperture and is movable to open the aperture by a reduced pressure within the tank body relative to an external pressure outside the tank body. The aperture comprises a vent and the external pressure is ambient atmospheric pressure. The ink tank is removable from the printhead for easy replacement, and is mounted on a carriage in the printer. The aperture comprises a vent and the external pressure is ambient atmospheric pressure.

Another embodiment of the present invention includes an inkjet printer with a printhead, an ink tank for the printhead and a remote ink supply to replenish the ink in the ink tank. The ink tank includes a tank body and an aperture leading to tubing that is outside the tank body, such that the tubing leads to the remote ink supply. A valve is biased to close the aperture and is movable to open the aperture by a reduced pressure within the tank body relative to an external pressure outside the tank body, where the external pressure is an external ink pressure.

These and other objects, features, and advantages of the present invention will become apparent to those skilled in the art upon a reading of the following detailed description when taken in conjunction with the drawings wherein there is shown and described an illustrative embodiment of the invention.

### BRIEF DESCRIPTION OF THE DRAWINGS

The above and other objects, features, and advantages of the present invention will become more apparent when taken in conjunction with the following description and drawings wherein identical reference numerals have been used, where possible, to designate identical features that are common to the figures, and wherein:

FIG. 1 is a schematic representation of an inkjet printer system;

FIG. 2 is a perspective view of a portion of a printhead chassis;

FIG. 3 is a perspective view of a portion of a carriage printer;

FIG. 4 is a schematic side view of an exemplary paper path in a carriage printer;

FIG. 5 is a cross sectional view of an ink tank according to an embodiment of the invention with the vent closed by a valve;

FIG. 6 is a cross sectional view of an ink tank according to an embodiment of the invention with the vent opened by a valve;

FIG. 7 is a graph of pressure at the outlet port of the ink tank versus time as ink is withdrawn at a constant rate;

FIG. 8 is an enlarged cross sectional view of a portion of the valve of FIG. 5;

FIG. 9 is a portion of a carriage printer according to an embodiment of the invention;

FIG. 10 is a cross sectional view of an ink tank according to an embodiment of the invention;

FIG. 11 is a cross sectional view of an ink tank according to an embodiment of the invention; and

FIG. 12 is a portion of a carriage printer with a remote ink supply connected to the ink tank of FIG. 11 according to an embodiment of the invention.

### DETAILED DESCRIPTION OF THE INVENTION

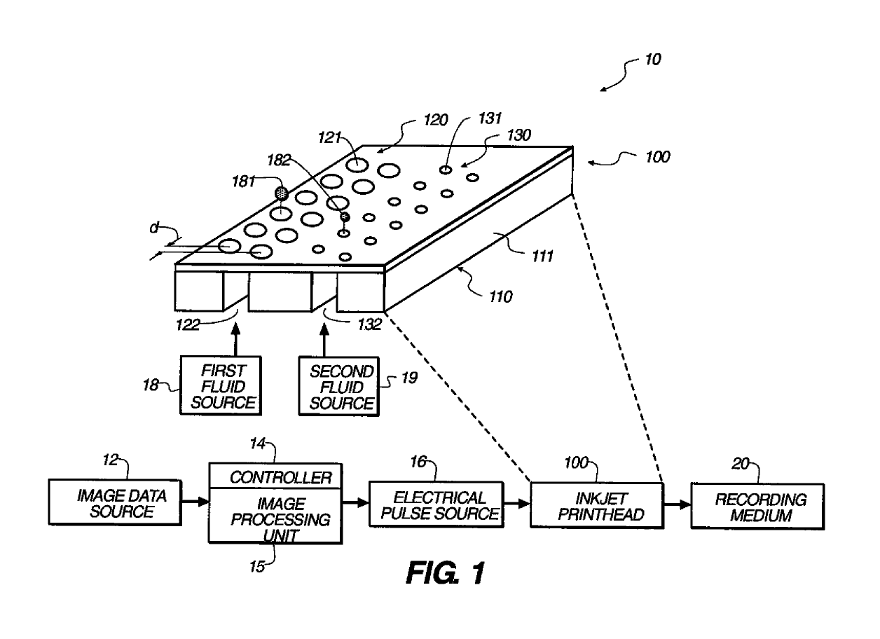

Referring to FIG. 1, a schematic representation of an inkjet printer system 10 is shown, for its usefulness with the present invention and is fully described in U.S. Pat. No. 7,350,902, and is incorporated by reference herein in its entirety. Inkjet printer system 10 includes an image data source 12, which provides data signals that are interpreted by a controller 14 as being commands to eject drops. Controller 14 includes an image processing unit 15 for rendering images for printing, and outputs signals to an electrical pulse source 16 of electrical energy pulses that are inputted to an inkjet printhead 100, which includes at least one inkjet printhead die 110.

In the example shown in FIG. 1, there are two nozzle arrays. Nozzles 121 in the first nozzle array 120 have a larger opening area than nozzles 131 in the second nozzle array 130. In this example, each of the two nozzle arrays has two staggered rows of nozzles, each row having a nozzle density of 600 per inch. The effective nozzle density then in each array is 1200 per inch (i.e. d= 1/1200 inch in FIG. 1). If pixels on the recording medium 20 were sequentially numbered along the paper advance direction, the nozzles from one row of an array would print the odd numbered pixels, while the nozzles from the other row of the array would print the even numbered pixels.

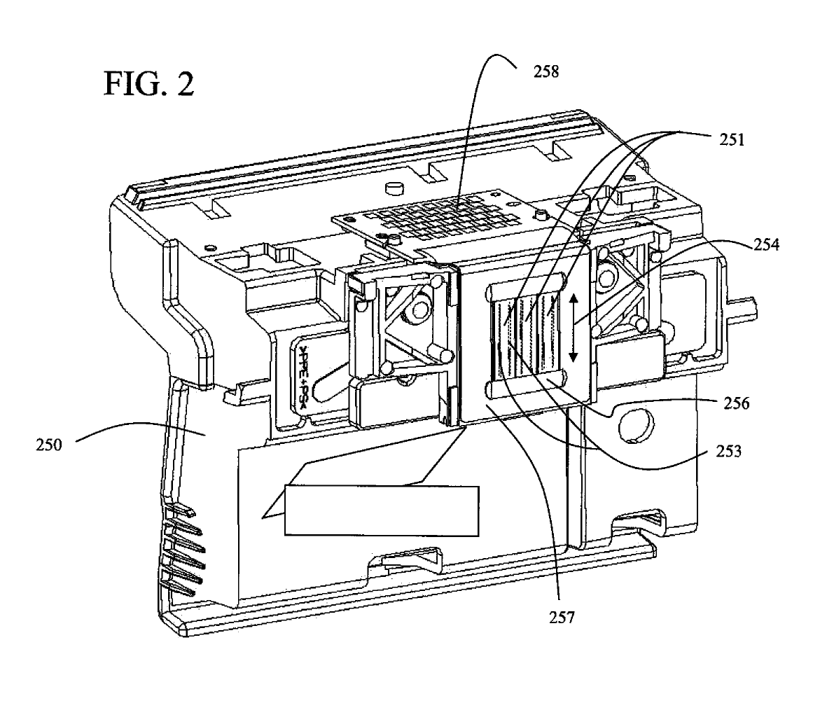

In fluid communication with each nozzle array is a corresponding ink delivery pathway. Ink delivery pathway 122 is in fluid communication with the first nozzle array 120, and ink delivery pathway 132 is in fluid communication with the second nozzle array 130. Portions of ink delivery pathways 122 and 132 are shown in FIG. 1 as openings through printhead die substrate 111. One or more inkjet printhead die 110 will be included in inkjet printhead 100, but for greater clarity only one inkjet printhead die 110 is shown in FIG. 1. The printhead die are arranged on a support member as discussed below relative to FIG. 2. In FIG. 1, first fluid source 18 supplies ink to first nozzle array 120 via ink delivery pathway 122, and second fluid source 19 supplies ink to second nozzle array 130 via ink delivery pathway 132. Although distinct fluid sources 18 and 19 are shown, in some applications it may be beneficial to have a single fluid source supplying ink to both the first nozzle array 120 and the second nozzle array 130 via ink delivery pathways 122 and 132 respectively. Also, in some embodiments, fewer than two or more than two nozzle arrays can be included on printhead die 110. In some embodiments, all nozzles on inkjet printhead die 110 can be the same size, rather than having multiple sized nozzles on inkjet printhead die 110.

Not shown in FIG. 1, are the drop forming mechanisms associated with the nozzles. Drop forming mechanisms can be of a variety of types, some of which include a heating element to vaporize a portion of ink and thereby cause ejection of a droplet, or a piezoelectric transducer to constrict the volume of a fluid chamber and thereby cause ejection, or an actuator which is made to move (for example, by heating a bi-layer element) and thereby cause ejection. In any case, electrical pulses from electrical pulse source 16 are sent to the various drop ejectors according to the desired deposition pattern. In the example of FIG. 1, droplets 181 ejected from the first nozzle array 120 are larger than droplets 182 ejected from the second nozzle array 130, due to the larger nozzle opening area. Typically other aspects of the drop forming mechanisms (not shown) associated respectively with nozzle arrays 120 and 130 are also sized differently in order to optimize the drop ejection process for the different sized drops. During operation, droplets of ink are deposited on a recording medium 20.

FIG. 2 shows a perspective view of a portion of a printhead chassis 250, which is an example of an inkjet printhead 100. Printhead chassis 250 includes three printhead die 251 (similar to printhead die 110 in FIG. 1), each printhead die 251 containing two nozzle arrays 253, so that printhead chassis 250 contains six nozzle arrays 253 altogether. The six nozzle arrays 253 in this example can each be connected to separate ink sources (not shown in FIG. 2); such as cyan, magenta, yellow, text black, photo black, and a colorless protective printing fluid. Each of the six nozzle arrays 253 is disposed along nozzle array direction 254, and the length of each nozzle array along the nozzle array direction 254 is typically on the order of 1 inch or less. Typical lengths of recording media are 6 inches for photographic prints (4 inches by 6 inches) or 11 inches for paper (8.5 by 11 inches). Thus, in order to print a full image, a number of swaths are successively printed while moving printhead chassis 250 across the recording medium 20. Following the printing of a swath, the recording medium 20 is advanced along a media advance direction that is substantially parallel to nozzle array direction 254.

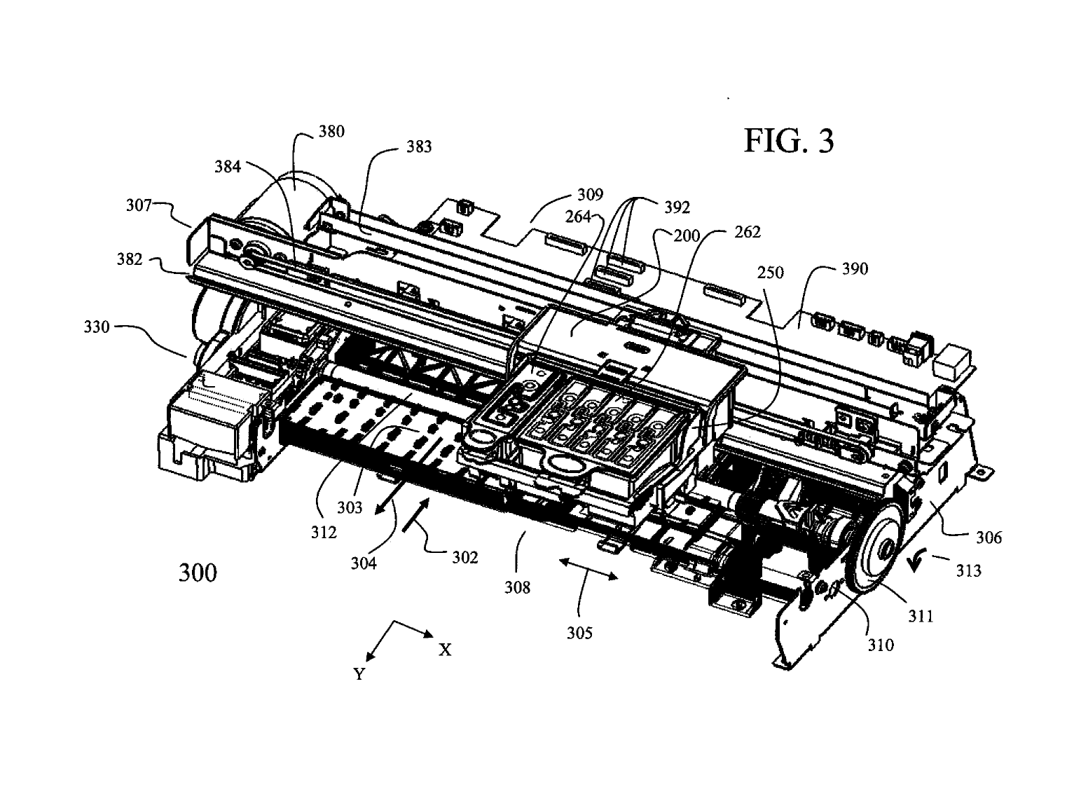

Also shown in FIG. 2 is a flex circuit 257 to which the printhead die 251 are electrically interconnected, for example, by wire bonding or TAB bonding. The interconnections are covered by an encapsulant 256 to protect them. Flex circuit 257 bends around the side of printhead chassis 250 and connects to connector board 258. When printhead chassis 250 is mounted into the carriage 200 (see FIG. 3), connector board 258 is electrically connected to a connector (not shown) on the carriage 200, so that electrical signals can be transmitted to the printhead die 251.

FIG. 3 shows a portion of a desktop carriage printer. Some of the parts of the printer have been hidden in the view shown in FIG. 3 so that other parts can be more clearly seen. Printer chassis 300 has a print region 303 across which carriage 200 is moved back and forth in carriage scan direction 305 along the X axis, between the right side 306 and the left side 307 of printer chassis 300, while drops are ejected from printhead die 251 (not shown in FIG. 3) on printhead chassis 250 that is mounted on carriage 200. Carriage motor 380 moves belt 384 to move carriage 200 along carriage guide rail 382. An encoder sensor (not shown) is mounted on carriage 200 and indicates carriage location relative to an encoder fence 383.

Printhead chassis 250 is mounted in carriage 200, and multi-chamber ink supply 262 and single-chamber ink supply 264 are mounted in the printhead chassis 250. The mounting orientation of printhead chassis 250 is rotated relative to the view in FIG. 2, so that the printhead die 251 are located at the bottom side of printhead chassis 250, the droplets of ink being ejected downward onto the recording medium in print region 303 in the view of FIG. 3. Multi-chamber ink supply 262, in this example, contains five ink sources: cyan, magenta, yellow, photo black, and colorless protective fluid; while single-chamber ink supply 264 contains the ink source for text black. Paper or other recording medium (sometimes generically referred to as paper or media herein) is loaded along paper load entry direction 302 toward the front of printer chassis 308.

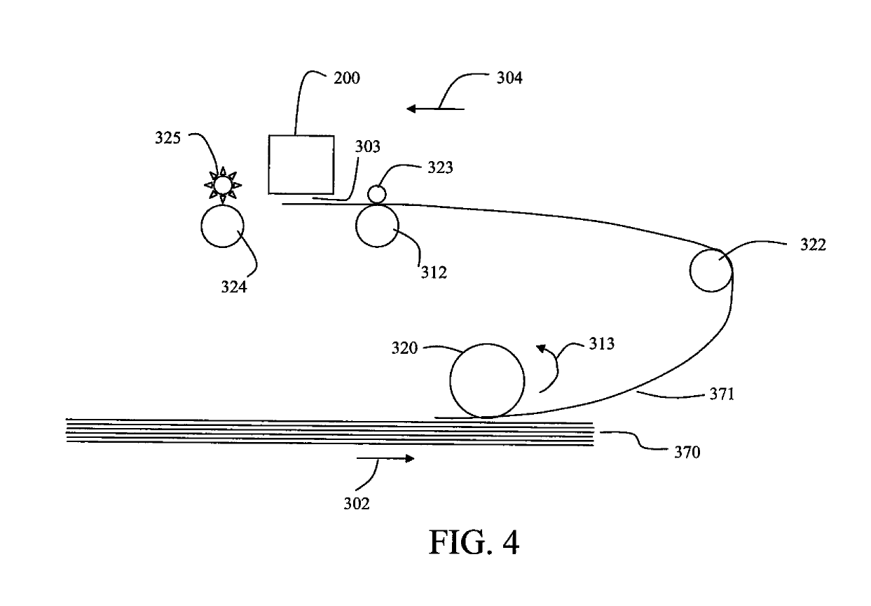

A variety of rollers are used to advance the medium through the printer as shown schematically in the side view of FIG. 4. In this example, a pick-up roller 320 moves the top piece or sheet 371 of a stack 370 of paper or other recording medium in the direction of arrow, paper load entry direction 302. A turn roller 322 acts to move the paper around a C-shaped path (in cooperation with a curved rear wall surface) so that the paper continues to advance along media advance direction 304 from the rear 309 of the printer chassis (with reference also to FIG. 3). The paper is then moved by feed roller 312 and idler roller(s) 323 to advance along the Y axis across print region 303, and from there to a discharge roller 324 and star wheel(s) 325 so that printed paper exits along media advance direction 304. Feed roller 312 includes a feed roller shaft along its axis, and feed roller gear 311 is mounted on the feed roller shaft. Feed roller 312 can include a separate roller mounted on the feed roller shaft, or can include a thin high friction coating on the feed roller shaft. A rotary encoder (not shown) can be coaxially mounted on the feed roller shaft in order to monitor the angular rotation of the feed roller.

The motor that powers the paper advance rollers is not shown in FIG. 3, but the hole 310 at the right side of the printer chassis 306 is where the motor gear (not shown) protrudes through in order to engage feed roller gear 311, as well as the gear for the discharge roller (not shown). For normal paper pick-up and feeding, it is desired that all rollers rotate in forward rotation direction 313. Toward the left side of the printer chassis 307, in the example of FIG. 3, is the maintenance station 330.

Toward the rear of the printer chassis 309, in this example, is located the electronics board 390, which includes cable connectors 392 for communicating via cables (not shown) to the printhead carriage 200 and from there to the printhead chassis 250. Also on the electronics board are typically mounted motor controllers for the carriage motor 380 and for the paper advance motor, a processor and/or other control electronics (shown schematically as controller 14 and image processing unit 15 in FIG. 1) for controlling the printing process, and an optional connector for a cable to a host computer.

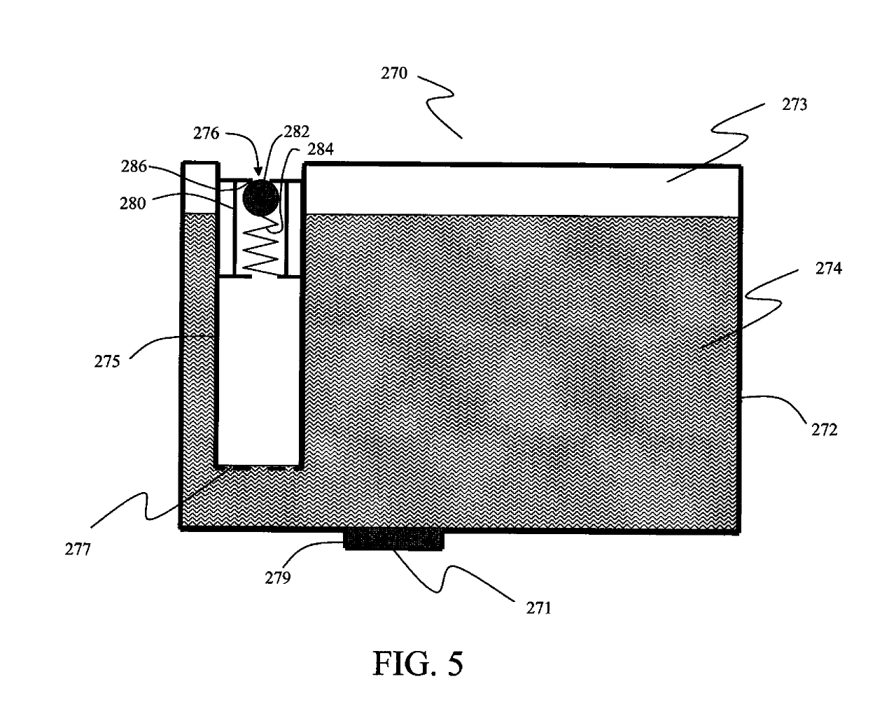

FIG. 5 shows a cross-sectional view of an ink tank 270 according to an embodiment of the invention. Ink tank 270 can be a chamber of multi-chamber ink supply 262 or single chamber ink supply 264 (see FIG. 3). Ink tank 270 can be replaceably removable from printhead chassis 250 (see FIGS. 2 and 3) or it can be permanently mounted on the printhead. Ink tank 270 includes a tank body 272 which contains a quantity of ink 274. Above the ink 274 is an airspace 273. Within the tank body 272 is an enclosure 275 that houses a valve 280. Valve 280 (also sometimes referred to as a check valve herein) includes a closing member such as a ball 282, and a valve seat 286. Ball 282 is substantially spherical and can be made of a compliant material such as an elastomer. Similarly, valve seat 286 can include a compliant material. The compliancy of the closing member or the valve seat 286 can improve the quality of the seal of the valve when it is closed. A spring 284 biases the ball 282 against the valve seat 286 under normal operating conditions. An aperture serving as a vent 276 leading to ambient atmospheric pressure is also included in the tank body near one end of enclosure 275. When check valve 280 is closed (i.e. when spring 284 pushes ball 282 into sealing contact against valve seat 286), air is not allowed to enter the tank body 272 through vent 276. In other words, the valve is biased to close the vent.

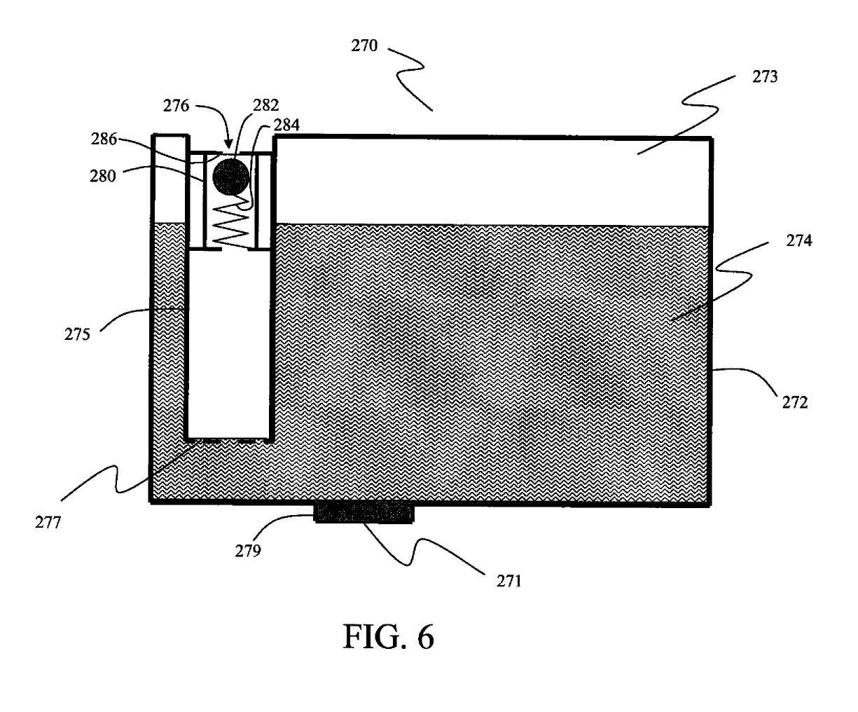

Ink tank 270 also includes an outlet port 279 which provides ink to the printhead (not shown in FIG. 5), for example through a wick 271. As ink 274 is extracted from ink tank 270 through outlet port 279 for printing or for printhead maintenance, the level of ink 274 in ink tank 270 decreases, as seen by comparing FIG. 6 to FIG. 5. As a result, the volume of the airspace 273 increases. Since pressure of a quantity of air is inversely proportional to its volume, as the airspace 273 increases without adding more air (with vent 276 closed as in FIG. 5), the pressure inside the ink tank 270 and at the outlet port 279 decreases relative to ambient pressure outside ink tank 270. As ink 274 continues to be extracted from ink tank 270, the pressure within the ink tank 270 becomes sufficiently reduced relative to ambient pressure that the bias force of spring 284 is overcome and the ball 282 of valve 280 moves away from valve seat 282 to open vent 276 as shown in FIG. 6. The incoming air enters enclosure 275 and can exit the enclosure 275 into the ink 274 through holes 277 in the end of the enclosure 275 that is in contact with the ink 274. When sufficient air has entered the vent 276, the spring 284 is again able to push ball 282 against valve seat 286 to close the vent 276.

The check valve 280 and vent 276 in this embodiment act as a pressure regulator for ink tank 270. The rate of change of pressure Pₚₒᵣₜ with time at outlet port 279 as ink 274 is extracted at an extraction rate Qₚₒᵣₜ prior to the opening of valve 280 to open vent 276 is calculated below. In this analysis, Pₐᵢᵣ is the pressure of the air in airspace 273, P₀ is the initial pressure of the air in airspace 273 before ink is extracted, ρ is the density of ink 274, h is the height of the ink above the bottom of ink tank 270, g is the acceleration due to gravity, V is the volume of the air in airspace 273, V₀ is the volume of air in airspace 273 before ink is extracted, and A is the cross sectional area of ink tank 270.

$${P}_{port} = {P}_{air} + ρ gh$$

$${P}_{air} ( t ) = {P}_{0} \frac{{V}_{0}}{V ( t )}$$

$$\frac{\partial {P}_{air}}{\partial t} = - {P}_{0} \frac{{V}_{0}}{{V}^{2}} \frac{\partial V}{\partial t}$$

$$\frac{\partial V}{\partial t} = {Q}_{port} , \frac{\partial V}{\partial t} = - A \frac{\partial h}{\partial t}$$

$$\begin{matrix}\frac{\partial {P}_{port}}{\partial t} = \frac{\partial {P}_{air}}{\partial t} + ρ g \frac{\partial h}{\partial t} \\ = - {P}_{0} \frac{{V}_{0}}{{V}^{2}} \frac{\partial V}{\partial t} + ρ g \frac{\partial h}{\partial t} \\ = - ( {P}_{0} \frac{{V}_{0}}{{V}^{2}} + \frac{ρ g}{A} ) {Q}_{port}\end{matrix}$$

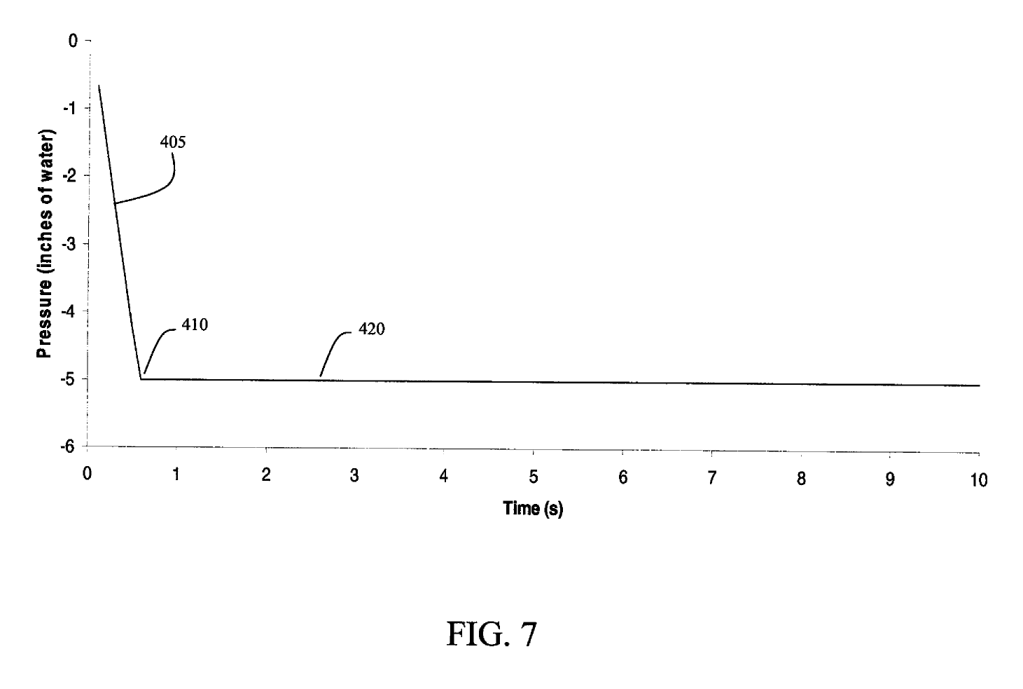

During extraction of ink 274 at a constant rate Qₚₒᵣₜ from outlet port 279 prior to the opening of valve 280, the pressure in ink tank 270 decreases nearly linearly with time for typical tank configurations. This linear approach toward the designed operating pressure of about—5 inches of water relative to ambient pressure is shown as line 405 in FIG. 7 where the ink extraction rate Qₚₒᵣₜ was 4 ml per minute. The valve 280 opens at point 410 in FIG. 7. Once the opening pressure of valve 280 is reached, air is allowed to flow into the ink tank 270, preventing further lowering of the pressure. Since the regulated air entering ink tank 270 is doing so at a fixed height (near the bottom of tank 270), the pressure at the outlet port 279 does not continue to change with decreasing ink level, but instead, remains at a substantially constant regulated pressure equal to the valve opening pressure, as shown by line 420 in FIG. 7.

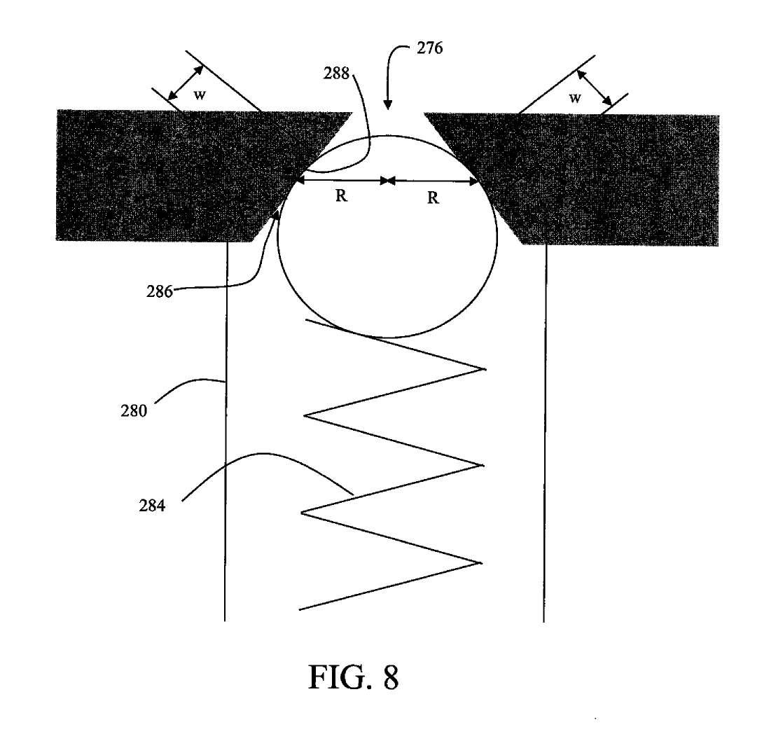

FIG. 8 shows an enlarged cross-sectional view of ball 282 in contact with valve seat 286. Valve seat 286 is conically shaped in this example and has an annular contact region 288 with ball 282. Contact region 288 has an area A_{c}. For an annular shaped contact region 288 having a width w and an average or midpoint radius R, the area A_{c} of contact region 288 is 2πRw. A compliant ball 282 and/or a compliant valve seat 286 will deform to an amount determined by the geometry, materials and load applied by spring 284. The spring can be chosen with a spring constant and a compression displacement to provide a spring force Fₛ to bias ball 282 against valve seat 286 that is approximately related to the opening pressure of the valve by Pₒₚₑₙ˜Fₛ/A_{c}=Fₛ/2πRw. The opening pressure Pₒₚₑₙ is the pressure difference between the ambient pressure and the reduced pressure within ink tank 270 that is sufficient to open check valve 280, and is also substantially equal to the constant operating pressure illustrated in FIG. 7 by line 420. Frictional forces in valve 280, as well as compression forces that deform the compliant ball 282 and/or valve seat 286 can cause Pₒₚₑₙ to deviate somewhat from Fₛ/A_{c}.

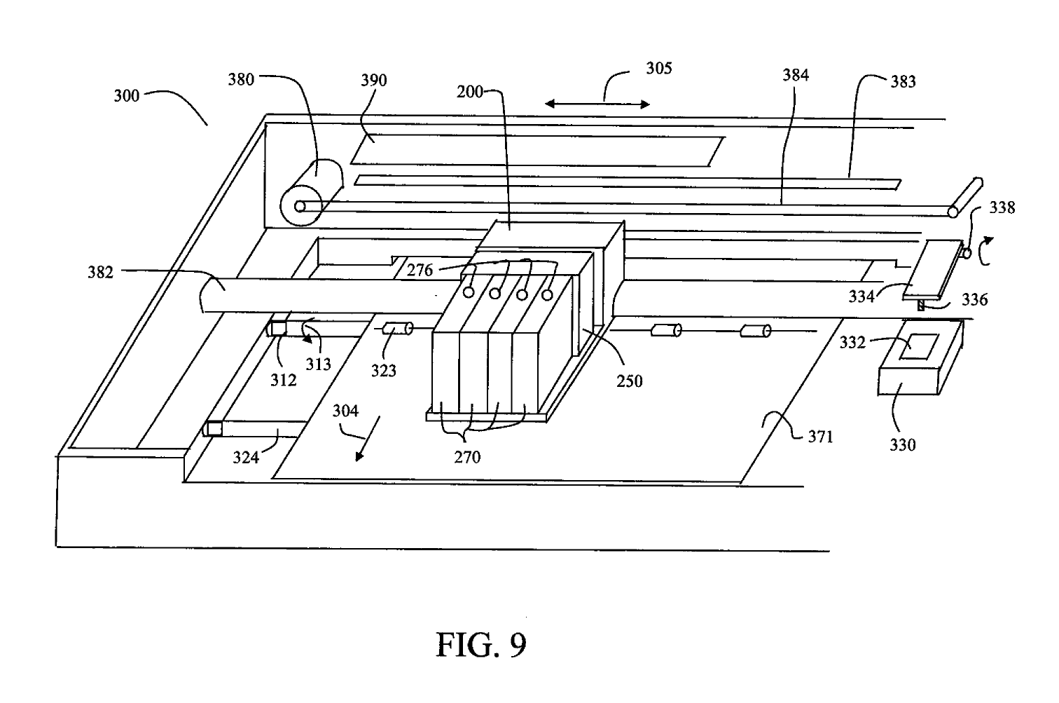

FIG. 9 show an embodiment of the present invention including individual ink tanks 270 mounted on a printhead chassis 250 that is mounted on a carriage 200 of an inkjet printer, a portion of which is shown. Many of the part numbers of this example are similar to parts shown in FIGS. 3 and 4 and will not be discussed further here. Each ink tank 270 includes a vent 276. The valve and some other components of the ink tank 270 that are shown in FIG. 5 are not shown in FIG. 9. In the embodiment shown in FIG. 9, a platform 334 including a finger 336 is mounted on rotational mount 338 above the maintenance station 330. The rotational mount 338 allows the platform to be rotated out of the way for normal operation. Since the sense of rotation of rotational mount 338 is similar to the forward direction 313 (and its reverse) of feed roller 312, rotation of the rotational mount 338 can be achieved by transmitting power from the paper advance motor (not shown) when needed. The purpose of finger 336 is to protrude into vent 276 and forcibly push down ball 282 (or other closing member) away from valve seat 286 of valve 280 (see FIGS. 5 and 6) if the pressure becomes excessive within one or more of the ink tanks 270. For example, if an ink tank 270 is partially depleted to the extent that the valve 280 has already opened to allow air to enter the tank through vent 276, and subsequently the tank is exposed to a sufficiently elevated temperature, the pressure in the tank can become greater than ambient pressure. As a result, pressure at the outlet port 279 can become high enough that ink is forced out of the nozzles of the printhead. To avoid this occurrence, ink level in ink tank 270 and ambient temperature can be monitored. If the conditions of ink level below a predetermined level and temperature above a predetermined temperature are encountered, printer controller 14 can cause carriage 200 to move the tank below the position of finger 336, and then rotate platform 336 to cause finger 336 to enter vent 276 and open valve 280 to relieve the excess pressure. Ink level can be monitored within the printer by knowing the initial fill level and tracking usage by counting ejected drops and multiplying by drop volume and counting maintenance operations and multiplying by volume of ink per maintenance operation. Temperature can be monitored within the printer by a temperature sensor that can be integrated into the printhead, or mounted on the printer electronics board 390, for example.

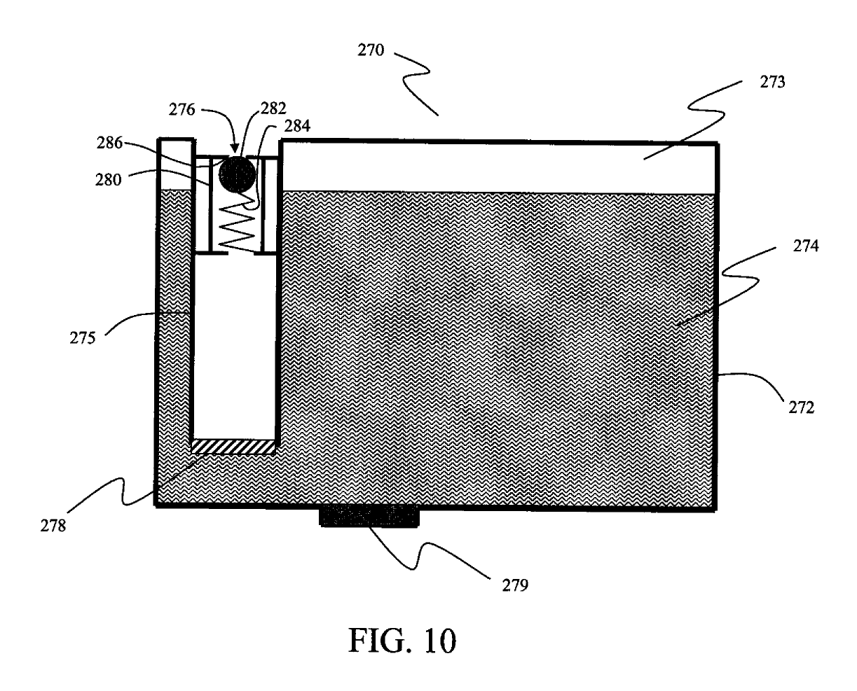

In the embodiments described above, the check valve 280 is used to regulate pressure in the ink tank 270 during usage of ink within the printer. In addition, check valve 280 keeps the pressure from reaching excessively negative levels even when ink is not being used—for example, during manufacture, storage or transportation when the ink tank 270 is not even installed in the printer. FIG. 10 shows an embodiment where check valve 280 prevents pressure from reaching excessively negative levels when ink is not being used, but capillary member 278 is used to regulate pressure in the ink tank 270 when ink is being used in the printer. Capillary member 278 is disposed at an end of enclosure 275 that is in contact with ink 274, i.e. opposite the end near which the vent 276 is located. In such an embodiment, pressure regulation is provided substantially as described in commonly assigned US Patent Application Publication 20090309940, incorporated herein in its entirety by reference.

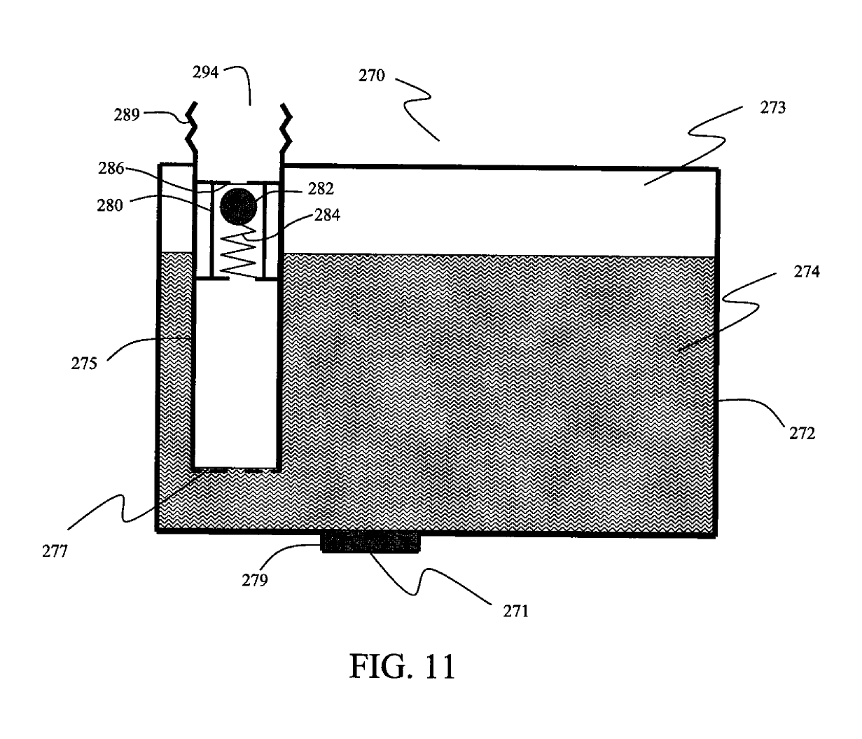

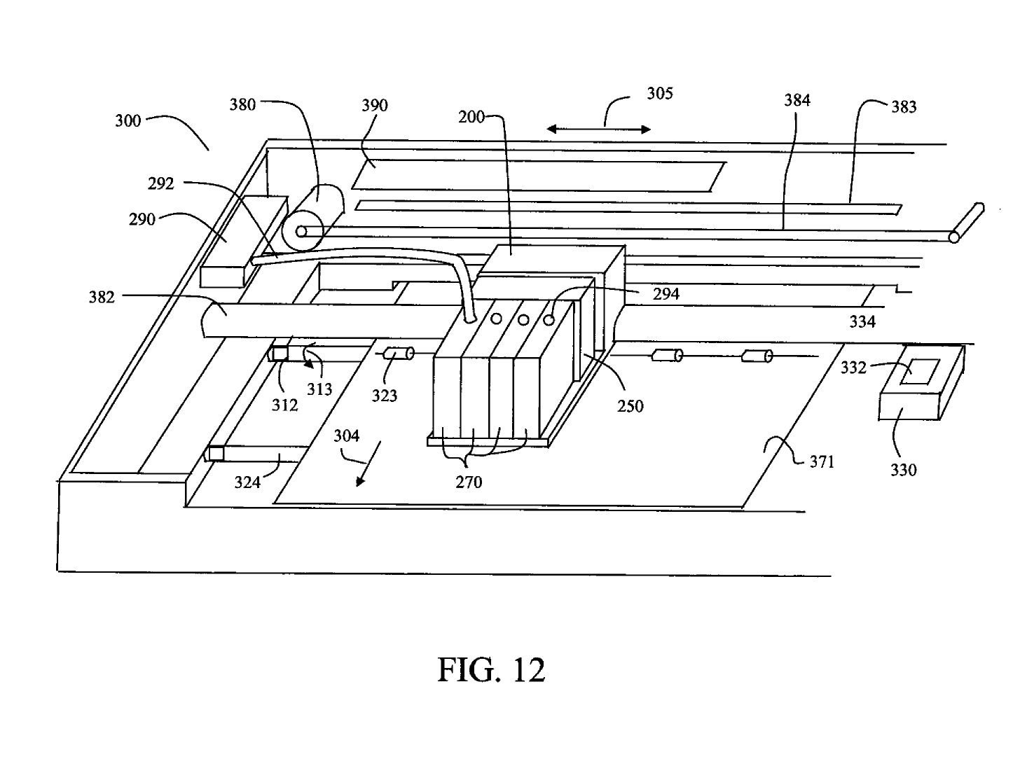

In the embodiments described above the aperture located in the tank body 272 near valve 280 has been a vent 276 to ambient atmospheric pressure. In the embodiments shown in FIGS. 11 and 12, the aperture is an inlet port 294. A fitting 289 allows flexible tubing 292 to be connected to the ink tank 270 (see FIG. 12, where, for clarity, tubing 292 is shown leading only to one ink tank 270). Tubing 292 leads to a remote ink supply 290 (sometimes called an off-axis ink supply) stationarily mounted on the printer chassis 300. When a sufficient amount of ink 274 is withdrawn from ink tank 270 for printing and/or maintenance, the pressure within the tank body 272 of ink tank 270 becomes reduced relative to the external ink pressure in the tubing 292 and remote ink supply 290. At a predetermined pressure within the ink tank 270 relative to the external ink pressure, valve 280 is configured to open (see FIG. 11), so that ink from the remote ink supply 290 can be replenished into ink tank 270. The predetermined pressure is related to the spring force provided by spring 284 that biases valve 280 to a closed position.

The invention has been described in detail with particular reference to certain preferred embodiments thereof, but it will be understood that variations and modifications can be effected within the spirit and scope of the invention.

### PARTS LIST

10 Inkjet printer system
12 Image data source
14 Controller
15 Image processing unit
16 Electrical pulse source
18 First fluid source
19 Second fluid source
20 Recording medium
100 Inkjet printhead
110 Inkjet printhead die
111 Substrate
120 First nozzle array
121 Nozzle(s)
122 Ink delivery pathway (for first nozzle array)
130 Second nozzle array
131 Nozzle(s)
132 Ink delivery pathway (for second nozzle array)
181 Droplet(s) (ejected from first nozzle array)
182 Droplet(s) (ejected from second nozzle array)
200 Carriage
250 Printhead chassis
251 Printhead die
253 Nozzle array
254 Nozzle array direction
256 Encapsulant
257 Flex circuit
258 Connector board
262 Multi-chamber ink supply
264 Single-chamber ink supply
270 Ink tank
271 Wick
272 Tank body
273 Airspace
274 Ink
275 Enclosure
276 Vent
277 Hole
278 Capillary member
279 Outlet port
280 Valve
282 Ball
284 Spring
286 Valve seat
288 Contact region
289 Fitting
290 Remote ink supply
292 Tubing
294 Inlet port
300 Printer chassis
302 Paper load entry direction
303 Print region
304 Media advance direction
305 Carriage scan direction
306 Right side of printer chassis
307 Left side of printer chassis
308 Front of printer chassis
309 Rear of printer chassis
310 Hole (for paper advance motor drive gear)
311 Feed roller gear
312 Feed roller
313 Forward rotation direction (of feed roller)
320 Pick-up roller
322 Turn roller
323 Idler roller
324 Discharge roller
325 Star wheel(s)
330 Maintenance station
332 Cap
334 Platform
336 Finger
338 Rotational mount
370 Stack of media
371 Top piece of medium
380 Carriage motor
382 Carriage guide rail
383 Encoder fence
384 Belt
390 Printer electronics board
392 Cable connectors
405 Line (pressure vs time before valve opens)
410 Point (time at which valve opens)
420 Line (pressure vs time after valve opens)

1. An ink tank for an inkjet printer, the ink tank comprising:
a tank body including ink;
an aperture leading to an outside of the tank body; and
a valve biased to close the aperture, wherein the valve is movable to open the aperture by a reduced pressure within the tank body relative to an external pressure outside the tank body.

2. The ink tank of claim 1, wherein the valve comprises a substantially spherical closing member.

3. The ink tank of claim 1, the valve comprising a closing member and a valve seat, wherein the closing member is biased against the valve seat by a spring.

4. The ink tank of claim 3, further comprising a contact region of area A_{c} between the closing member and the valve seat, wherein the reduced pressure within the tank body relative to external pressure to open the aperture is approximately equal to Fₛ/A_{c}, where Fₛ is the force exerted by the spring to bias the closing member against the valve seat.

5. The ink tank of claim 4, wherein the contact region is annular in shape.

6. The ink tank of claim 3, wherein the closing member is made of a compliant material.

7. The ink tank of claim 3, wherein the valve seat is made of a compliant material.

8. The ink tank of claim 1, the valve being disposed within an enclosure within the tank body, wherein the enclosure includes a first end proximate the aperture and a second end proximate the ink.

9. The ink tank of claim 8 wherein the second end of the enclosure includes a plurality of holes.

10. The ink tank of claim 1, wherein the aperture comprises a vent and the external pressure is ambient atmospheric pressure.

11. The ink tank of claim 10 further comprising an outlet port including a pressure at the outlet port, wherein prior to the opening of the vent, a rate of decrease of the pressure at the outlet port is substantially proportional to a rate of extraction of ink from the ink tank through the outlet port

12. The ink tank of claim 11, wherein after the opening of the vent, the pressure at the outlet port remains substantially equal to a constant regulated pressure as ink continues to be extracted through the outlet port.

13. The ink tank of claim 12 further comprising a contact region of area A_{c} between the closing member and the valve seat, wherein the constant regulated pressure is approximately equal to Fₛ/A_{c}, where Fₛ is the force exerted by the spring to bias the closing member against the valve seat.

14. The ink tank of claim 10 further comprising a capillary member disposed at the second end of the enclosure.

15. An inkjet printer including a printhead and an ink tank for the printhead, wherein the ink tank comprises:
a tank body including ink and an aperture leading to outside the tank body; and
a valve biased to close the aperture, wherein the valve is movable to open the aperture by a reduced pressure within the tank body relative to an external pressure outside the tank body.

16. The inkjet printer of claim 15, wherein the ink tank is replaceably removable from the printhead.

17. The inkjet printer of claim 15 further comprising a carriage, wherein the ink tank and the printhead are mounted on the carriage.

18. The inkjet printer of claim 15, wherein the aperture comprises a vent and the external pressure is ambient atmospheric pressure.

19. The inkjet printer of claim 18 further comprising a member configured to open the valve and bleed out air to reduce pressure within the tank body.

20. The inkjet printer of claim 19, wherein the member is rotationally mounted.

21. The inkjet printer of claim 15, wherein the aperture comprises an inlet port that is connected by tubing to a remote ink supply, and wherein the external pressure is an external ink pressure.

22. The inkjet printer of claim 21, wherein the valve is configured to open at a predetermined pressure within the ink tank relative to the external ink pressure.
